(19) United States
(12) Patent Application Publication
(10) Pub. No.: US 2003/0180695 A1
(43) Pub. Date: Sep. 25, 2003

(54) Base structure for holding removable basin

(76) Inventor: William H. Peters, West Unity, OH (US)

Correspondence Address: George R. Royer, Suite 416, 316 N. Michigan Street, Toledo, OH, 43624, US

(21) Appl. No.: 10/101,803

(22) Filed: Mar. 21, 2002

(51) Int. Cl. G09B 29/00

(52) U.S. Cl. 434/150

(57) ABSTRACT

The subject invention is a centered on an improved base structure with detachable container means as used by young children for educational purposes, such container means having a depressed area in the middle portion of such depressed area, with the upper portion of the frame being flanked by a plurality of upwardly extending support arms extending upwardly from the upper outer perimeter of the base member, with the upper portion of the upper support arms having holding means thereon to securely hold upright and additionally support laterally a portion of a basin member such that the basin is held securely within the restricted area of the frame structure.

### DISCUSSION OF PRIOR ART AND BACKGROUND OF INVENTION

The subject apparatus is directed to items that are used to help educate young children, particularly pre-school children in learning activities. Many of these educational items are adapted and structured to permit young children to use their hands in combined play and work activities.

One such apparatus used in the educational development of young children is sand and water activity structure that features a tub-like member in which a container area is formed to allow children to manipulate and work with the dampened sand. Generally, these tub-like members have a depressed container area which is formed to allow children to manipulate and work with various materials, substances, or objects for educational purposes. Usually, these tub-like members are supported on an upright frame with the depressed container area disposed on the upper portion of the frame with the depressed container area being accessible for use while the child stands-or is seated near the unit. These latter described structures, along with other play type table structures are not suitable for holding removable containers that require frequent disposal of the contents for cleanliness purposes, or where removal of the container is necessary for other purposes.

There are several structures in existence adapted for these functions. However, none of these devices are properly suitable for holding the tub-like contained in a secure posture. Moreover, some structures have a common restriction for viewing the contents of the container by reason of supporting frame members that block out a side view of the container and thereby permit or only allow a downward vertical view of the container, and thereby prohibiting a three hundred and sixty degree viewing of the container. Other difficulties characterize devices in the existing art as used in this area.

This invention is conceived as an improvement over the relevant devices in the existing art, and the following objects of the subject invention are directed accordingly.

### OBJECTS OF THE INVENTION

The following are objects of the subject invention:

It is an object of the subject apparatus to provide an base mobile frame structure for supporting a removable basin;

It is also and object of the subject invention to provide a mobile frame that has means structured thereon to hold a removable basin in an upright position;

An additional object of the subject invention is to provide an improved structure to accommodate holding a portable basin in a secure position;

A further object of the subject invention is to provide an improved structure to hold a portable container for use by children;

Yet, another aspect of the subject invention is to provide an improved structure to hold a portable container for use by children;

A further object of the subject invention is to provide an improved structure for usage by children that has means to hold a container in an upright position;

Still another object of the subject invention is to provide a mobile framed structure that holds and maintains a basin therein for usage by young children for educational purpose;

An object is to provide a mobile frames structure to hold a portable container in a physical relationship that permits viewing the contents of the container from any angle whether vertically, horizontally or combination of such angles;

Moreover, it is an object of this invention to provide a container retention means to prevent any container from accidentally stripping from its support portion as provided in the upright angular support frame means, with a portion of the support portion being at a higher elevation, to maintain in position such elevated portion of a turned down portion of the circumferential flange the container, thereby preventing horizontal movement of container when any one side of the container is lifted up from above.

Other and further objects of the subject invention will become apparent from reading the description taken in conjunction with the claims.

### IN THE DRAWINGS

FIG. 1 is a perspective view of the subject invention;

FIG. 2 is a top elevational view of the support pad used in the preferred embodiment of the subject invention;

FIG. 3 is a side elevational view of the support pad;

FIG. 4 is a top elevational view in cross section of the support pads on which is placed a basin member;

FIG. 4A is a top elevational view a support pad showing a corner portion of a basin fitted therein;

FIG. 5 is a top elevational of an alternative preferred embodiment for the structure of the support pad;

FIG. 6 is a perspective view of the support pad in the preferred embodiment;

FIG. 7 is a perspective view of the basin structure used in conjunction with the subject invention;

FIG. 8 is a side elevational view of the base frame member used in conjunction with the subject invention.

### DESCRIPTION OF GENERAL EMBODIMENT AND SUMMARY OF INVENTION

The subject invention is a centered on an improved base structure with detachable container means as used by young children for educational purposes, such container means having a depressed area in the middle portion thereof, with the upper portion of the frame being flanked by a plurality of upwardly extending support arms extending upwardly from the upper outer perimeter of the base member, with the upper portion of the upper support arms having holding means thereon to securely hold upright and additionally support laterally a portion of a basin member such that the basin is held securely within the depressed area of the frame structure.

Alternately stated, the subject apparatus is centered on an improved base structure comprising generally a frame-like base member which is open at the top for access from above, or has an upper area adapted to receive and retain a removable basin for use by individuals for various purposes. Such a base structure would incorporate or have means to support the removable basin in the intended position of usage, and also permit removal of the base when needed by an upward movement only.

In the most general embodiment of the subject invention, the invention comprises a base member having a portion over which a removable basin is to be supported with the open portion of the basin facing upwardly so that the basin can be used or be accessible from above the frame. It is contemplated that one can place any array of objects or materials into such basin for study or play or even storage functions. For example, in some instances the basin maybe adapted to hold on its lower or upper portions organic or nonorganic substances for viewing or use in biological experiments or activities, with the lower portion filled with soil or other substances to livingly support biological activities of organisms to be grown or studied. The contemplated usage of the basin is not to be so limited, as other uses may be made of such basin.

The uppermost extent of the base member as stated, may have a continuous upper perimeter edge which is generally horizontal when the base member is placed in position for usage, or it may have a discontinuous perimeter formed by separate support arms, in which event the upper portions of the support arm form the means to support the basin upright. For this support function, however, the general focus of the invention herein is directed to one or more upwardly extending support arms that extend upwardly from such perimeter portions of the base frame which arms have means thereon to securely hold the disposable basin just on or above the upper portion of the base member. It is further contemplated that for safety and other purposes the basin be removable only by pulling it directly upwardly away from such support arms. In this respect, each upperwardly extending support arm has means thereon to hold upwardly a portion of the basin, such means permitting, as stated, the removable basin to be removed by upwardly movement only. Other means of supporting the basin may be used including the possible use of means that interlock the basin to the base member.

### DESCRIPTION OF PREFERRED EMBODIMENT OF SUBJECT INVENTION

A preferred embodiment of the subject invention is set forth below and such description of a preferred embodiment is not to be construed as limiting the scope of the subject invention to such description as set forth in the annexed claims. Thus, the following description does not preclude the inclusion of other embodiment is described in the following description does not preclude the inclusion of other embodiment is within the scope of the claims. Moreover, while the subject invention is focused and centered on a mobile frame like member with wheels on the lower portion, as the base support member, the invention can be structured and deployed other than as a frame member or other than as a mobile frame, so long as means exist to support such basin in an upright position, preferably on or above the upper portion of the base member.

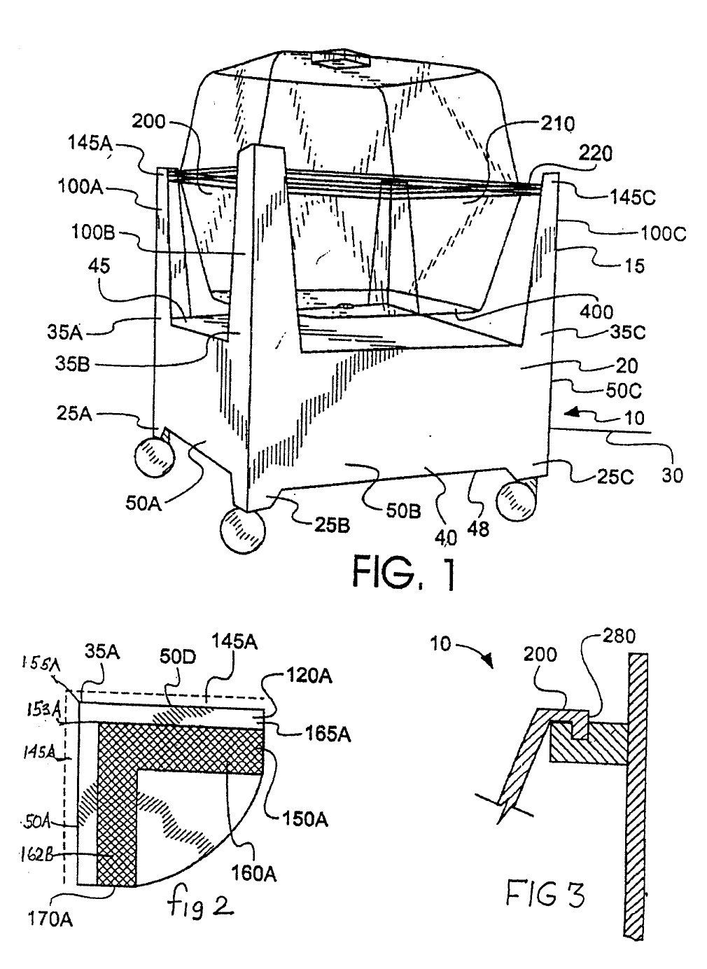

Attention is addressed to the drawings in which a preferred embodiment of the subject invention as shown. A frame like member 10 is shown in FIG. 1 as being structured with an upright base member 20, with multiple vertical leg members 25A, 25B, 25C and 25D, adapted to extend downwardly from the based member to support the base member above or on the ground or the floor area 30. The form structure and number of such support legs, 25A, 25B, 25C, and 25D, may vary and are not crucial to implementing of the subject invention so long as the base member 20 is supported upright above or on the ground on the floor. Moreover, the invention may contemplate that the base member 20 may merely set on the ground or floor 30 on its lower surface 40 or be simply suspended or supported by other means in which event no support legs are needed. In the embodiment shown in FIG. 1, an optional arrangement is displayed that includes wheels 28A, 28B, 28C, 28D, affixed to the lower portion of respective support legs to facilitate movement of the frame member 10 over the floor.

In the preferred embodiment the base member 20 can be formed as a frame structure or other member. As stated, it is to be noted that the fact that the invention described herein is set forth as a frame member with vertically disposed supporting legs does not alter the aspect that the subject invention need not be formulated, structured or incorporated in a frame as such, as the subject invention can be focused on other support members. Variously stated the subject invention may include a base frame without legs. In short, the invention herein can be incorporated in most any type of structure having means to receive and hold a portion of a permanent or removable basin member as more fully described below.

Moreover, it is to be stressed that by describing the base frame 10, with an upper support member 15, having four support members being downwardly extending support legs 25A, 25B, 25C, and 25D, does not preclude using a base member from having other shapes and supporting mans than as shown and described. These variations may include among other variations, for support purposes, using any number of legs or no legs at all, with such arrangement still falling within the scope of the subject invention. In the primary embodiment of this invention, it is preferable that such support legs be affixed on the lower portions of respective corner portions 35A, 35B, 35C, and 35D, of the base frame 20.

Attention is again addressed to the drawings, in which the base frame 20 is shown, such base frame is adapted to be disposed above or on the floor member and may be formed as a parallel-piped member with a bottom surface 40 and vertical side walls 50A, 50B, 50C, and 50D of any height, which are joined together on their respective end edges in a box like manner and rectangular fashion, without the downwardly supporting legs. Again, in the preferred embodiment the base member 20 is formed as a rectangular member having an upper surface 45 and lower surface portion 40 with the base member 20 being formed as a rectangular member, with the upper surface 45 and lower surface 40 being preferably flat or otherwise formed. Thus, the upper surface 45 holds the upper support member 15 comprising in the preferred embodiment the upper projecting support arms 100A, 100B, 100C, and 100D. It is also to be noted at this juncture that the frame may be of any shape other than a box like rectangular member as described above. It is noted that upper support member 15 may be structured other than upwardly direct support legs as support legs as described above.

More specifically, as seen in the drawings, in the preferred embodiment of the subject invention, integrally positioned on the respective upper corner portions 35A, 35B, 35C, and 35D, of the upper surface 45 of the frame member 20 are upperwardly extending basin support arms, 100A, 100B, 100C, and 100D, that are substantially vertical members that extend upwardly generally in a perpendicular direction relative to the upper surface 45 of the base frame member 20. Each such basin support arm 100A, 100B, 100C, and 100D, in the preferred embodiment extends the same distance above such upper surface 45, of the frame member 20. Each of the support arms 100A, 100B, 100C, and 100D, thus are of equal height above upper surface 45 of the frame member in the preferred embodiment, so that when supporting a basin placed over the subject support arms the basin will be held in a level position as more fully described below. Each of the support arms 100A, 100B, 100C, and 100D, has a similarly structured level ledge portions 120A, 120B, 120C, and 120D, near the upper portions of the support arms that function as level support surfaces for holding corner portions of a basin as more fully described below. These level ledge portions 120A, 120B, 120C and 120D, are generally preferably substantially perpendicular to the vertical axis of each support arm as can be seen in the drawings, with such upper level ledge portions of each support arm 100A, 100B, 100C, and 100D, respectively having means to provide upward support for a portion of a basin resting thereon as well as means to hold the basin from any lateral movements, as also more fully described below. In the preferred embodiment of the subject invention these upper ledge portions 120A, 120B, 120C, and 120D, are rectangular in configuration, as observed from an upper elevational view. This latter rectangular shape is not critical to implementation of the subject invention, so long as there is some type of alternate such shape or level ledge surface is provided upon which a portion of the basin can be positioned and supported upright and laterally as more fully described below.

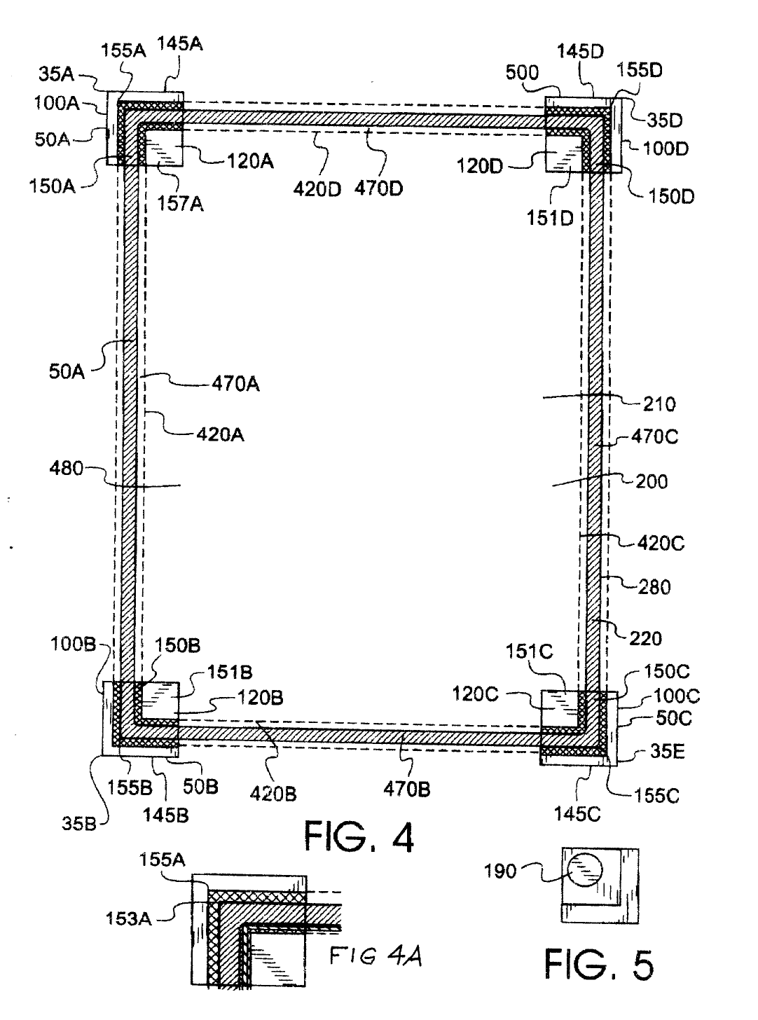

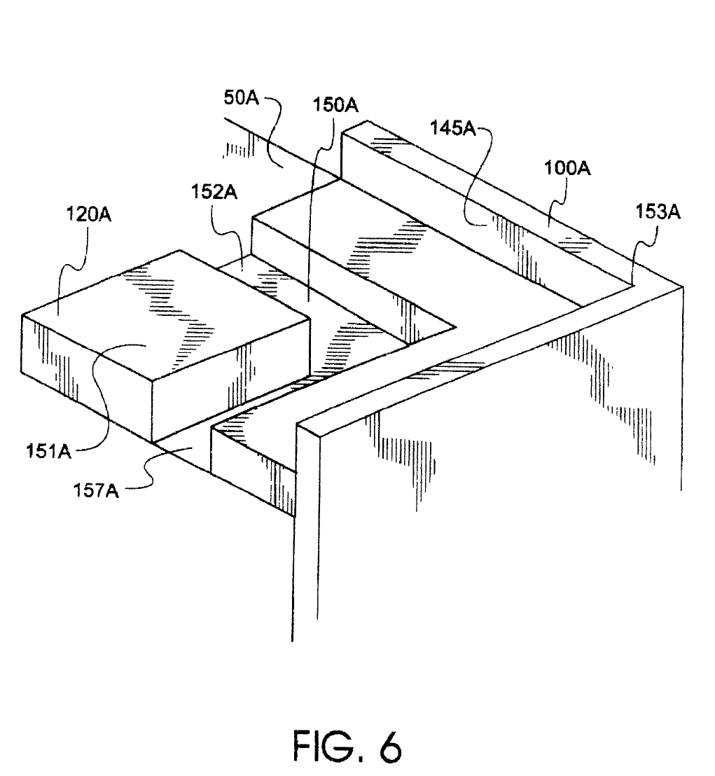

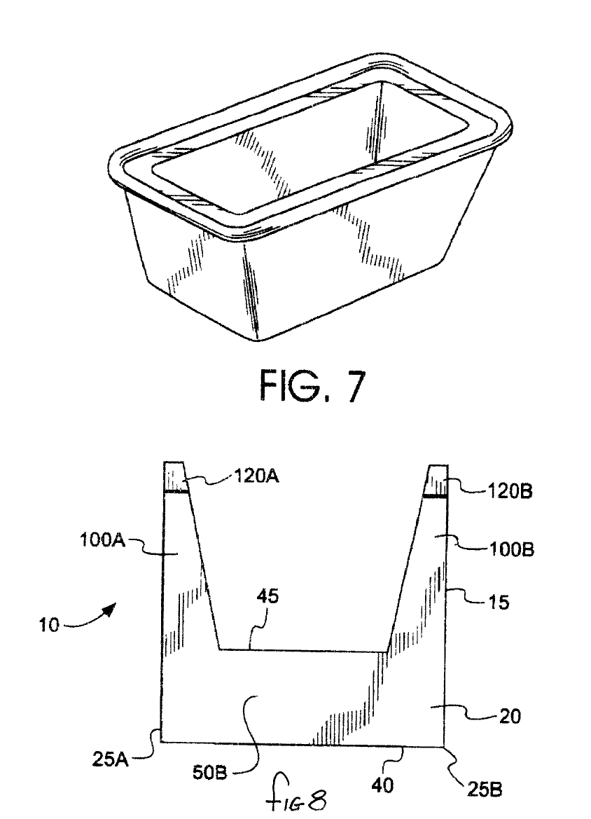

As seen in the drawings each of the ledge portions 120A, 120B, 120C, and 120D is flanked by perpendicularly angled upwardly extending bracing portions 145A, 145B, 145C, and 145D. These bracing portions 145A, 145B, 145C, and 145D are disposed on the outer upper edges of each support arm 100A, 100B, 100C, and 100D and help to serve as auxiliary lateral barriers to keep the adjacent portion of the basin within the confines of the support arms from lateral movement. For this latter function, these bracing portions 145A, 145B, 145C, and 145D, extend upwardly beyond the respective level ledge portions, 120A, 120B, 120C, 120D, and this feature may be optional although preferable to the invention. As seen in the drawings channels 150A, 150B, 150C, and 150D are formed with mutually perpendicular sub channel portions into the upper surface 151A, 151B, 151C, and 151D of each ledge portion 120A, 120B, 120C, and 120D. More specificially, these channels are formed, with mutually perpendicular sub channel portions or more specificially perpendicular channel legs, such as sub channel legs 160A and 162A, for support ledge 120A, which lattter sub channels hoin in an apex 153A. As seen in FIG. 2 the apex portion 153A of ledge 120A is disposed near the outer corner 155A of the support ledge, such outer corner being flanked by the perpendicular bracing portions 145A. As can be seen the in FIG. 2, the outer ends of each sub-channel leg, 160A and 162 is open and faces toward the respective inner sides of the ledge member 120. Each of the other respective supprt ledges, 120B, 120C, and 120D has similarly formed channels in the upper surface thereof, as seen in FIG. 2 for ledge 120, with each sub-channel of all such support legs being coaxially and longitudinally aligned with the opposing other channel legs on the other support ledge portions 120A, 120B, 120C, 120D, so that by extending the respective longitudinal axes of each sub-channel member, as represented in FIG. 4, is formed as a regular perimeter of rectangular configuration part of which is imaginary, and part of which is comprised of the actual channels in the support ledge members.

More specifically, as seen in the drawings formed into the upper surface of each of the ledge portions 120A, 120B, 120C, and 120D is a right angled channel in the upper surface thereof, such as channel 150A, formed into the ledge 120A. As stated, as can be seen in the drawings, the channel member 150A is formed of two mutually perpendicular sub-channels 160A and 162A. These sub-channels 160A and 162A meet at a common apex 153A to form a continuous right angled channel the apex of which points to the outer adjoining corner 155A of the support ledge 120A. In particular, in support ledge 120 the sub-channel leg 160A extends all the way to and through adjoining inner side 165A of support ledge 120A and sub-channel 162A extends all the way to and through the other adjoining inner side 170A of such ledge. By these features the sub-channel members 160A and 162A will be open on such latter sides. In an alternative embodiment as shown in FIG. 5, the upper surface of each ledge portion has a rounded knob 190 which protrudingly upward in lieu of channel members.

Thus, as described above the respective channels 150A, 150B, 150C, and 150D in each support ledge 120A, 120B, 120C, and 120D can become unified by an imaginary line and act as essentially as one continuous perimeter channel on the upper perimeter of the frame member 20. Alternatively, as another support feature, the upper portion of the frame 20 member may have formed thereon as one continuous physical channel member on its upper surface without the vertical support arms.

In the preferred embodiment of the subject invention, a basin member 200 is shown as being compatible in shape and structure to use with the base fame member 20 described herein. The basin member 200 has a recessed area 210 and an upper perimeter edge 220 which is adapted to placed over the top of the support ledge portions 120A, 120B, 120C, and 120D. More particularly, the rectangular tray-basin member 200 is formed with an upper perimeter edge 220 that has an outwardly directed downturned rimmed portion 280 that extends over the edge 270 of the basin all the way around the outer upper perimeter thereof. The corner portions of the of the and downward portioned 280 of such upper perimeter edge of the basin 200 are shaped and sized to fit conformingly over the support portion 120A, 120B, 120C, and 120D so that the basin 200 is supported over such legs with the downwardly turned corners 290A, 290B, 290C, and 290D of the downwardly turned portion 280 of such basin 200 being slightly lower than the level of the ledges 120A, 120B, 120C, and 120D. With this latter relationship the right angled corner portions 290A, 290B, 290C, and 290D of such downturned portion 280 of basin 200 are structured and sized as to fit conformingly down into the right angled channels 150A, 150B, 150C, and 150D. By having the corner portions of the downturned rim portion 280 fitting downwardly into the channels the basin 200 will be locked against lateral movement in any direction, as well supported upwardly by the support ledge 120A, 120B, 120C, and 120D. By this means inadvertent bumping of the basin 200 from the side will not result in movement of the basin off the frame, as the only way the basin can be removed is by a substantive vertical upright movement. The right angled brace members 145A, 145B, 145C, and 145D also function as a back up against lateral movement that have cause the basin to slide off the supports and move laterally with a downward dipping of the basin.

In the preferred embodiment of the subject invention, the rectangularly structured basin 200 has a recessed area 290 and has an additional perimeter means to permit a similarly shaped basin member, as seen in FIG. 1 to be placed over the top of the upper perimeter at the lower basin in an inverse or upside down manner to serve as a cover for the lower basin. This upper basin would be held so that it also cannot be removed from the lower basin by an upward movement only.

The basin 200 as stated, is formed with a recessed portion 290 that is open at the top. This recessed portion of basin 200 is the area in which sand, water, and other substances can be placed for work or play purposes or can be used for storage; or other educational or play purposes.

In the preferred basin 200 is formed with flat bottom surface 400, which is flanked by four vertical side walls 420A, 420B, 420C, and 420D. The vertical side walls each sharper edge surface 470A, 470B, 470C, and 470D, and since these vertical side walls are all joined together at their respective vertical side edges, they form a continuous and solid vertical side that basically and generally forms the vertical part of the recessed basin 200, and since these walls are joined in and with the bottom surface 400 of the basin 200, at the recessed portion of the basis is effectively an enclosed member having a continuous, solid surface except for an opening 480 on the upper part of the basin that exposes the basin to the outside and provides access from or to the basins for a person to work with the contents of the basin.

Moreover, Basin 200 can be constructed from a clear material which enhances the ability to view the contents, such as clear composition of allowing from a universal three-hundred-sixty degree angle. From above or the sides, at an elevational viewing perspective.

1. A structure for holding a tray over the upper portion thereof having an open basin wherein said tray has an upper perimeter portion over the surrounding opening to said open basin portion of the tray, said structure comprising:
(a) a base member having a lower portion and an upper portion, said base member being adapted to rest in part on a building floor;
(b) a plurality of support members disposed on the upper portion of said base member, each of said support members having means thereon to hold a part of the upper perimeter portion of said tray to hold the tray upright over the upper portion of said base member with said open basin of said tray exposed upwardly.

2. A structure for holding a tray over the upper portion thereof having a basin wherein said tray has a downwardly turned portion over at least part of its perimeter upper portion thereof, said structure comprising:
(a) a base member having a lower portion and an upper portion, said base member being adapted to rest in part on a floor;
(b) a plurality of support member disposed on the upper portion of said base member having means thereon to hold a portion of said tray over the upper portion of said structure.

3. A structure of holding a tray over the upper portion thereof of said tray having a basin wherein said tray has a laterally flanged portion over at least part of the upper perimeter portion of said tray, said structure comprising:
(a) a base member having a lower portion and an upper portion, said base member being adapted to rest in part on a building floor,
(b) a plurality of upwardly extending support members disposed n the upper portion of said base member each said support members having means thereon to hold a portion of the lateral flanged portion on to support the tray above the base member.
